(19) United States
(12) Patent Application Publication
(10) Pub. No.: US 2006/0217956 A1
(43) Pub. Date: Sep. 28, 2006

(54) Translation processing method, document translation device, and programs

(75) Inventors: Takashi Nagao, Ashigarakami-gun (JP); Masakazu Tateno, Ashigarakami-gun (JP); Kei Tanaka, Ashigarakami-gun (JP); Kotaro Nakamura, Minato-ku (JP); Masayoshi Sakakibara, Ebina-shi (JP); Xinyu Peng, Ebina-shi (JP); Teruka Saito, Ashigarakami-gun (JP); Toshiya Koyama, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/197,508

(22) Filed: Aug. 5, 2005

(30) Foreign Application Priority Data
Mar. 25, 2005 (JP) 2005-090203

(51) Int. Cl. G06F 17/28

(52) U.S. Cl. 704/2

(57) ABSTRACT

A translation processing method comprising: registering a type of annotation with a corresponding translation rule in a table; identifying a text to be processed; extracting a type of annotation and character information from the text identified at the identifying step; identifying a text element to which the annotation extracted at the extracting step is to be added; determining a translation rule corresponding to the type of annotation by referring to the table; and translating the text element identified in the annotation identifying step, by applying the translation rule determined at the translation rule determining step is provided.

### BACKGROUND OF THE INVENTION

1. Field of the Invention

The present invention relates to a method for improving the quality of a machine translation.

2. Description of the Related Art

As a result of significant advances in global electronic communication, for machine translation from one language to another is increasing. A machine translation is performed by using a computer to replace character (words) with another character (words), by analyzing the characters and applying dictionary data or a predetermined algorithm to thereby translate from a specific language to a different language. If a text is not stored in a computer-readable format, in other words, if character information is not included in the text, prior to translation process, it is necessary to perform an OCR process for reading a printed text by a scanner device, to perform a character recognition process, and to extract character information.

One advantage of machine translation is that it is possible to translate a large amount of document in a short time; a disadvantage is that the quality of the translated document is usually of a relatively low standard. One reason for this disadvantage is that the machine translation process uses rules such as dictionary data or algorithms, and these rules are not flexibly adaptable depending on a type of a document to be translated; or example, a business document or a technical document. As a result, some of the translated words do not convey the original meaning. Therefore, to improve the quality of a machine-translated text it is necessary for a person to check the translated text and replace the unsuitable translated word to a suitable word. There exist several techniques for assisting a person related to correcting a machine-translated text. It is known to provide a technique wherein translations of specific words in an original text are displayed between the lines of the original text. It is also known to provide a technique wherein specific words in an original text and their translations are listed.

According to the techniques described above, it is possible to display on a screen an original text in contrast with machine-translated text, thereby making it easier for a person to rewrite a machine-translated text. However, a problem exist that it is necessary for a person to manually input suitable translations for every unsuitable translation. This problem reduces any advantage of performing a machine translation.

### SUMMARY OF THE INVENTION

The present invention has been made in view of the above circumstances.

To address the stated problems described above, the present invention provides a translation processing method including: registering a type of annotation with a corresponding translation rule in a table; identifying a document to be processed; extracting an annotation added to a text element from the identified document; identifying a type of the extracted annotation added to the text element; and translating the text element according to the registered translation rule corresponding to the identified type of the extracted annotation.

### BRIEF DESCRIPTION OF THE DRAWINGS

Embodiments of the present invention will be described in detail based on the figures, wherein:

FIG. 1 is a diagram showing the configuration of document translation device 1 according to one embodiment of the present invention.

FIG. 2 is a diagram explaining a flow of the processes executed in document translation device 1.

FIG. 3 A is a diagram showing one example of an original text which is a translation object,

FIG. 3 B is a diagram showing one example of a text during processing of a translations

FIG. 3 C is a diagram showing one example of a text during a process of being edited

FIG. 3 D is a diagram showing one example of a text that is being edited.

FIG. 4 is a diagram showing correspondences between types of annotations and editing styles.

FIG. 5 is a diagram showing a table of correspondences between a designated word, a dictionary to be used, and a priority order of dictionaries to be used

### DETAILED DESCRIPTION OF THE INVENTION

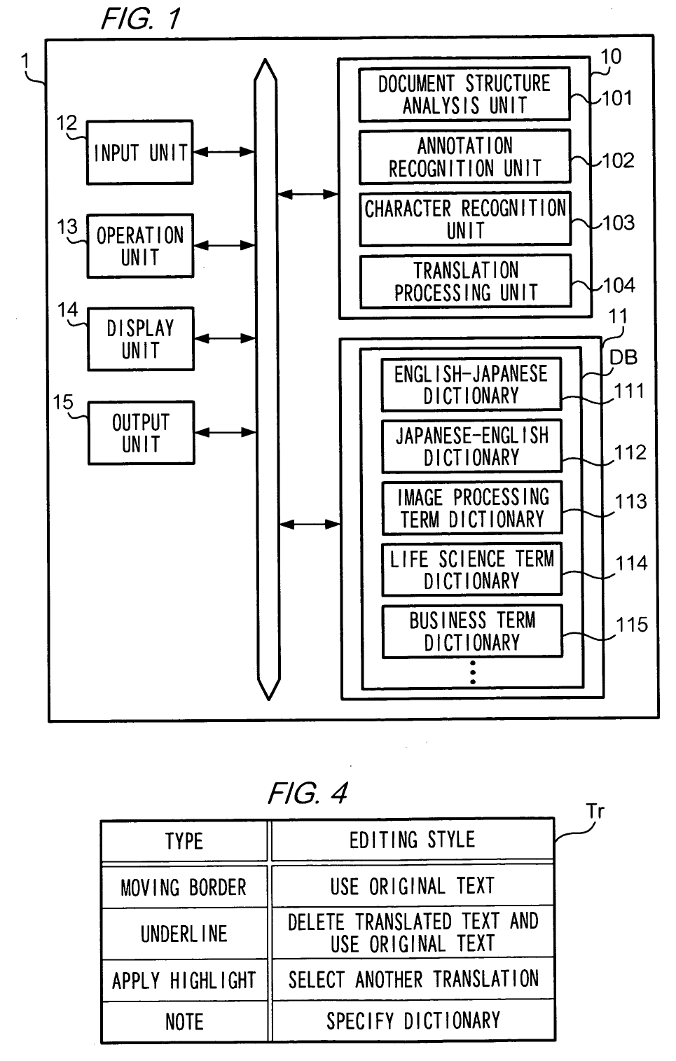

Refining next to the drawings, preferred embodiments of the present invention will be explained FIG. 1 is a diagram showing the functional configuration of document translation device 1 according to one embodiment of the present invention. As shown in the figure, document translation device 1 having: a control unit 10; a memory 11; an input unit 12; an operation unit 13; a display unit 14; and an output unit 15. Control unit 10 has a processor for causing a CPU to control each unit in document translation device 1. Furthermore, control unit 10 has a document structure analysis unit 101, an annotation recognition unit 102, a character recognition unit 103, and a translation processing unit 104. Document structure analysis unit 101, using a predetermined algorithm, performs a layout analysis for a document scanned by input unit 12, and determines a layout structure of the document as image data. More specifically, the document structure analysis unit 101 determines whether both a word and a symbol (additional information such as illusion, ruled line, or memo (hereafter referred to as annotation)) are included in the document. If annotation is included in the document, an area including character portions and an area including annotation portions are separated.

Annotation recognition unit 102 performs a predetermined analysis process of image data of an area, excluding separated and extracted characters, to determine the type of annotation and the portion where the annotation is added (namely, elements that form a text such as a word and a term). The type of annotation that is extracted includes items such as a sticky tag, a moving border, an underline, a highlight, a leader line, and a note (words inserted between lines of an original text). Information relating to a type of annotation and a portion to which the annotation is to be added are stored in memory 11. Character recognition unit 103 performs a character recognition process on an area separated and extracted by document structure analysis unit 101 and extracts character information (a lexical token) to store them in memory 11. Translation processing unit 104 uses dictionary data stored in memory 11 and a predetermined algorithm to substitute character information extracted by character recognition unit 103 so as to perform a translation process in which the language of the document is translated to a language specified by a user. The text data being translated and the relations between the words in an original text and the words in translation are stored in memory 11.

For image data of a document to which annotation is added, document structure analysis unit 101, annotation recognition unit 102, character recognition unit 103, and translation processing unit 104 are used to perform a translation process for annotated and character portions; wherein, a function for extracting information relating to the type of the annotation, to words in an original text to which annotation is to be added, and to the translated words for each annotation is realized. Details of the process performed in control unit 10 will be given below. The functions of each unit realized in control unit 10 may be realized by each individual processor, or by one processor running a plurality of software applications.

Memory 11 is a storage device such as RAM, ROM, and hard disk; the memory stores dictionary database DB or other reference data used when performing the above process at control unit 10. As shown in FIG. 1, database DB stores various dictionary data 111˜115 which may be used in a translation process. Database DB further stores translation rule table Tr (described in detail later) storing a type of annotation in correspondence with an editing style. Database DB further stores dictionary table Tp (described in detail later) storing the correspondence between a specific word and a priority order in which dictionaries are to be used in translating the word.

Input unit 12 refers to, for example, a scanner device which scans documents printed on paper as digital image data and provides the data to both control unit 10 and memory 11. Operation unit 13b refers to an input device such as a keyboard or a mouse; the operation unit is used when a user of document translation device 1 specifies a document to be translated, writes information in a dictionary table Tp and a translation rule table Tr, specifies a portion to be edited, or inputs any other necessary information. The input instruction or information is provided to control unit 10. Display unit 14 has a processor for drawing (not shown) and a display device such as a liquid crystal display (not shown); the display unit, when given an instruction from control unit 10, displays on a screen an original text, a document undergoing translation, or various types of messages for a user. A user refers to a display screen of display unit 14 and inputs instructions through input unit 12 so as to have document translation device 1 executing various processes. Output unit 15 is a printer for printing the edited script on paper, a communication interface for providing to a printing device text data acquired after additional information editing pr s have been performed, or a storage device for storing text data in a storage medium such as a flash memory or a CD-ROM.

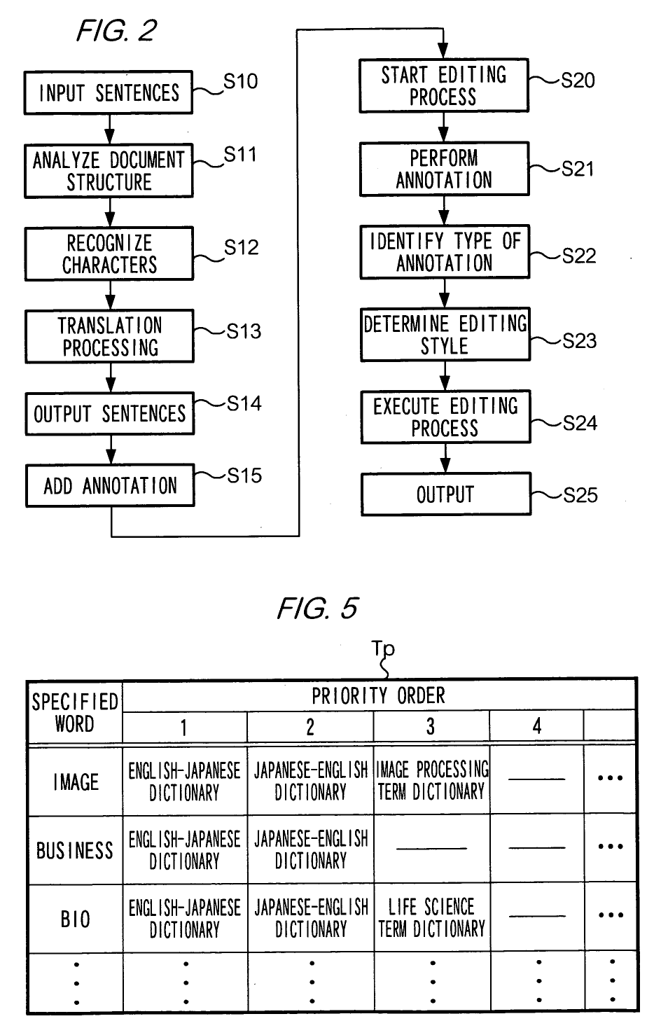

Referring next to FIG. 2˜FIG. 5, one operational example of document translation device 1 will be explained. It is to be noted that necessary information is pre-stored in translation rule table Tr shown in FIG. 4 and dictionary table Tp shown in FIG. 5.

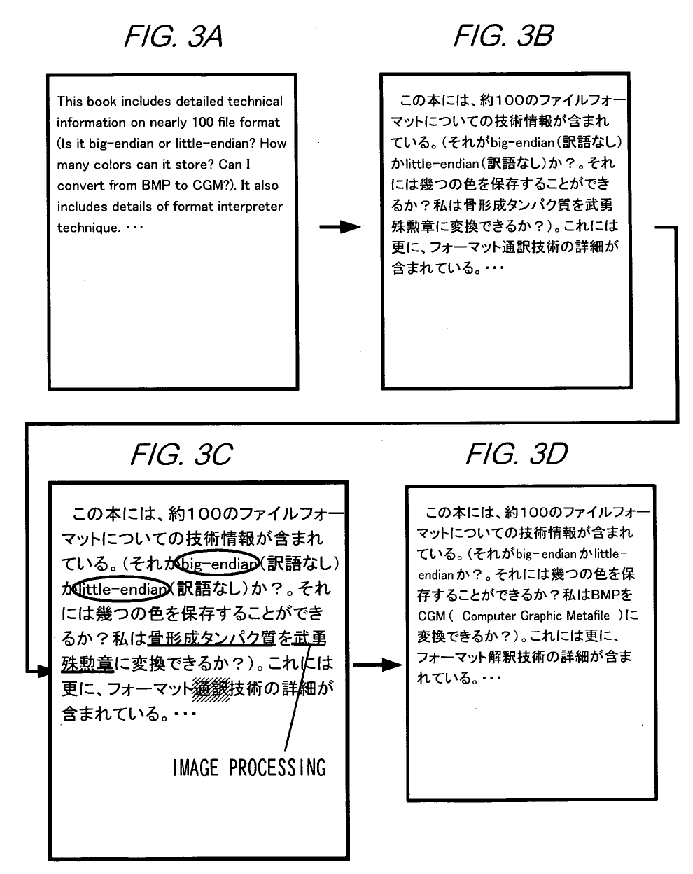

FIG. 2 is a diagram showing a flow of a registration process of characteristic information. As shown in the figure, a user inputs a predetermined inspection to specify both the original language and the type of language to be translated, sets a document which the user wants to translate (hereinafter, such a document will be referred to as translation object document) on a scanner device, and scans the document to acquire image data (step S10). In the description below, an example is given with respect to a case wherein English text is translated into Japanese. FIG. 3 A is a diagram showing one example of an original text which constitute a translation object. Referring again to FIG. 2, the area including characters is identified by analyzing the document structure of the acquired image data (step S11), and character information is extracted after character recognition process (step S12). Then, translation process is performed on the extracted character information (step S13) and the translation result is output to display unit 14 (step S14). It is to be noted that the dictionary data used in the translation process is set in advance. Specifically, an English-Japanese dictionary 111, which is a standard dictionary, is selected. One example of the translated text is shown in FIG. 3 B. Control unit 10 displays on a display screen of display unit 14 a message such as “Translation completed. If there is any editing object portion, please designate it”, thereby urging a user to confirm such a portion.

Referring again to FIG. 2, a user refers to a display screen to check whether there are any mistranslations or any portion on which an unsuitable translation process has been performed. When identifying a mistranslation, a user adds an annotation, corresponding to the editing style the user desires, to the mistranslated portion (step S15). Referring to FIG. 3 C, the process will be shown in detail. In the figure, an example is shown wherein a user identifies an stable translation process at five parts in total: “big-endian (no translation)”, “little-endian (no translation)”, “osteogenesis protein”, “heroic story medal”, and “interpreter”. The “big-endian” and “little-endian” are technical computer terms; therefore, no suitable translation is included in English-Japanese dictionary 111 used in the translation process. For this reason, a term “no suitable word exists” is added to the text “Osteogenesis protein”, “heroic story medal”, and “interpreter” are incorrectly translated as “BMP”, “CGW”, and “interpretation”, respectively. When identifying a mistranslation, as an editing object portion, a user adds a predetermined annotation to the translation by use of a mouse or a keyboard.

More specifically, as shown in FIG. 4, annotation corresponding to the editing style that a user desires is added. For example, when a user wishes to keep “big-endian” and “little-endian” as they are, because they are technical computer term a and are usually used in their original language (namely, the user wishes to edit “big-endian (no translation)” as “big-endian” and “little-endian (no translation)” as “little-endian”), moving borders are added to the words as an annotation. In the original text, “osteogenesis protein” corresponds to “BMP”; therefore, if a user considers that direct application of the original text is the best (namely, editing “osteogenesis protein” as “BMP”), an annotation process such as underlining “osteogenesis protein” is performed. As for “interpreter”, if a user desires to apply a definition given a subsequent priority among alternative words included in English-Japanese dictionary 111, a highlight is applied to the translated “interpreter”. As for “heroic story medal”, when a user selects a dictionary suited to the field of the document and wishes to apply a translation registered in the dictionary (such as “CGM (Computer Graphic Metafile)”), a leader line and a word designating the field of the document (in the present case, “image processing”) are added as annotation The annotation may also be displayed around the translated text as shown in the display screen of FIG. 3 C, so that a user is able to keep in mind the corresponding section of the application By checking the correspondence shown in FIG. 4, a user is able to identify the type of annotation corresponding to the desired editing style.

Referring again to FIG. 2, when a user inputs a predetermined instruction to determine an editing object portion and its annotation and complete the process of adding desired annotation to the desired editing object portion, image data corresponding to the text added annotations shown in FIG. 3 C is generated and editing process for the image data (retranslation process) is initiated (step S20). Then, document structure analysis for the image data is performed at document stub analysis unit 101, and character information and annotation are separated and extracted (step S21). Following step S21, annotation recognition unit 102 determines for each annotation the translated portion to which annotations are added and the type of the annotations (step S22). It is to be noted that, annotation is added (“image process” in the example of FIG. 3 (b)), a character recognition process is performed to identify the character.

The process then proceeds to step S23, wherein, a translation rule table Tr is referred to and the editing style corresponding to the identified annotation type is determined. In this step, when a note is identified in the table as an annotation, the document structure analysis unit refers to a dictionary table Tp to determine the dictionary corresponding to the character included in the note and the priority order for using each dictionary. FIG. 5 illustrates the storage contents of a dictionary table Tp. As shown in the figure, dictionary table Tp is registered with a usable dictionary and its priority order in correspondence with a specified word. For example, if a note of “image processing” is added, the word includes a specified word “image” which is registered in a dictionary table Tp; therefore, a dictionary is used in the order of English-Japanese dictionary 111, Japanese-English dictionary 112, and Image processing term dictionary 113. In other words, for translating the word which is the object of the note (“heroic story medal” in the example of FIG. 3 C; referred to CGM in an original text), the previously used English-Japanese dictionary 111 is excluded as a candidate. “Japanese-English dictionary 112” which is next in order of priority is excluded, because the dictionary is used only for Japanese-English translation Consequently, it is determined that the translation process is performed by applying image processing term dictionary 113 which is third in order of priority to the editing object word (COM). As a result, “CGM (Computer Graphic Metafile)” is selected as a translation for “CGM” registered in image processing term dictionary 113.

Refer again to FIG. 2, when the editing style is determined, an editing process in accordance with the editing style (translation process) is performed (step S24). FIG. 3 D shows a text wherein the above described editing object portions (five in total) are each edited in accordance with a corresponding editing style. Control unit 10 then displays on a display screen of display unit 14 a message such as “Editing (retranslation) process is completed. To add any editing object portions, please specify them again”, thereby encouraging a user to check the editing result. In the case of determining that the editing was not satisfactory or indicating another mistranslation in another part of the text, a user inputs a predetermined instruction. In response to the instruction, the process returns to step S15 of FIG. 2 so as to again accept the designation of editing object portion. When satisfied with the edited contents, the user inputs a predetermined instruction to terminate the translation process. The accepted translation is output in a predetermined manner (step S25).

As described above, by using document translation device 1, a user confirms the translated document and corrects the mistranslated part by specie both the portion that is to be edited and the editing style, using an annotation. Thus, it is possible to acquire a translation with high quality in a short time, without placing an excessive burden on a user.

<Modifications>

The present invention is not limited to the embodiments described above, and may be modified in various ways. The modifications will be shown below. In the embodiments described above, a standard dictionary (English-Japanese dictionary 111) is used by document translation device 1 for performing a translation process (temporarily translation process) and a user specifies an editing object portion after checking the translation result; in another embodiment an annotation may also be added to an original text and the translation process may be performed on the basis of the annotation. Namely, the original text with an attached annotation is read by a scanner, and the type of the annotation and the portion to which the annotation is added are identified so that the translation style is determined (whether the original text is preferable, which dictionary is to be used, and a priority order) after referring to both translation rule table Tr and dictionary table Tp. In this embodiment, translation process is omitted one time; therefore, the present embodiment is more effective in a case that a user is able to predict the part where a mistranslation is likely to happen after checking the original text.

When adding an annotation to a temporally translated text, a document including the text may also be printed on such as a paper so that a user is able to write the annotation on the paper. In such a case, it is required to rescan the document with the annotation so that image data of the document is acquired.

Furthermore, in the embodiments described above, an editing (retranslation) process is performed after specifying every editing object portion; however, an editing process may also be performed each time an annotation is added to an editing object portion.

Needless to say, the contents of a document, the type of annotation, the specific wording of a note, and the dictionary used are not limited as in the case described above.

To address the stated problems described above, the present invention provides a translation processing method including: registering a type of annotation with a corresponding translation rule; identifying a document to be processed; extracting an annotation added to a text element from the identified document; identifying a type of the extracted annotation added to the text element; and translating the text element according to the registered translation rule corresponding to the identified type of the extracted annotation. According to an embodiment of the invention, a user specifies a part that is to be an edition object so that a desired translation rule is applied to the part at the time of translation, thereby improving the quality of translation.

In other embodiment, a translation processing method of the present invention wherein the type of annotation is registered with a corresponding translation rule in a table.

In an embodiment, the translation rule includes designation of a dictionary used in a translation process, or the dictionary is used according to a priority of the dictionary.

In an embodiment, the present invention provides a document translation device comprising: memory that stores a type of annotation with a corresponding translation rule in a table; identifying part that identifies a document to be processed; extracting part that extracts a type of annotation and character information from the document identified at the identifying part; annotation identifying part that identifies a text element to which the annotation extracted at the extracting step is to be added; translation rule determining part that determines a translation rule corresponding to the type of annotation by referring to the table; and translation performing part that translates the text element identified in the annotation identifying pan, by apply the translation rule determined at the translation rule determining part.

In an embodiment, the present invention provides a computer readable program that enable a computer to act as: a memory that stores a type of annotation with a corresponding translation rule; an identifying part that identifies a document to be processed; an extracting part that extracts an annotation added to a text element from the document identified by the identifying part; an annotation identifying part that identifies a type of the annotation added to the text element extracted by the extracting part; and translation performing part that translates the text element according to the translation rule corresponding to the type of the annotation identified by the annotation identifying part.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments, and with the various modifications as are suited to the particular use contemplated. It is intended that the scope of the invention be defined by the following claims and heir equivalents.

The entire disclosure of Japanese Patent Application No. 2005-90203 filed on Mar. 25, 2005 including specification, claims, drawings and abstract is incorporated herein by reference in its entirety.

What is claimed is:

1. A translation processing method comprising:
registering a type of annotation with a corresponding translation rule;
identifying a document to be processed;
extracting an annotation added to a text element from the identified document;
identifying a type of the extracted annotation added to the text element; and
translating the text element according to the registered translation rule corresponding to the identified type of the extracted annotation.

2. The translation processing method according to claim 1, wherein the type of annotation is registered with a corresponding translation rile in a table.

3. The translation processing method of claim 1, wherein the translation rule includes designation of a dictionary used in a translation process.

4. The translation processing method of claim 3, wherein the dictionary is used according to a priority of the dictionary.

5. A document translation device comprising:
a memory that stores a type of annotation with a corresponding translation rule;
an identifying part that identifies a document to be processed;
an extracting part that extracts an annotation added to a text element from the document identified by the identifying part;
an annotation identifying part that identifies a type of the annotation added to the text element extracted by the extracting pat; and
translation performing part that translates the text element according to the translation rule corresponding to the type of the annotation identified by the annotation identifying part.

6. The document translation device according to claim 5, wherein the type of annotation is registered with a corresponding translation rule in a table.

7. The document translation device according to claim 5, wherein the translation rule includes designation of a dictionary used in a translation process.

8. The document translation device according to claim 7, wherein the dictionary is used according to a priority of the dictionary.

9. A computer readable program that enable a computer to act as:
a memory that stores a type of annotation with a corresponding translation rule;
an identifying part that identifies a document to be processed;
an extracting part that extracts an annotation added to a text element from the document identified by the identifying part;
an annotation identifying part that identifies a type of the annotation added to the text element extracted by the extracting part; and
translation performing part that translates the text element according to the translation rule corresponding to the type of the annotation identified by the annotation identifying part.

10. The computer readable program according to claim 9, wherein the type of annotation is registered with a corresponding translation rule in a table.

11. The computer readable program according to claim 9, wherein the translation rule includes designation of a dictionary used in a translation process.

12. The computer readable program according to claim 11, wherein the dictionary is used according to a priority of the dictionary.

13. A translation processing method comprising:
registering a type of annotation with a corresponding translation rule in a table;
identifying a document to be processed;
extracting a type of annotation and character information from the document identified at the identifying step;
identifying a text element to which the annotation extracted at the extracting step is to be added;
determining a translation rule corresponding to the type of annotation by referring to the table; and
translating the text element identified in the annotation identifying step, by applying the translation rule determined at the translation rule determining step.
